(19) United States
(12) Patent Application Publication
(10) Pub. No.: US 2005/0101371 A1
(43) Pub. Date: May 12, 2005

(54) Method and apparatus for gaming

(75) Inventors: Jerald C. Seelig, Absecon, NJ (US); Lawrence M. Henshaw, Hammonton, NJ (US)

Correspondence Address: IAN F. BURNS & ASSOCIATES, 1575 DELUCCHI LANE, SUITE 222, RENO, NV, 89502, US

(73) Assignee: Atlantic City Coin & Slot Service Company, Inc., Pleasantville, NJ (US)

(21) Appl. No.: 10/944,076

(22) Filed: Sep. 15, 2004

Related U.S. Application Data
(60) Provisional application No. 60/503,308, filed on Sep. 15, 2003.

(51) Int. Cl. A63F 13/00

(52) U.S. Cl. 463/20; 463/25

(57) ABSTRACT

One embodiment of a gaming device, which is comprised of a gaming device wherein player(s) can play at least one game, the gaming device is in communication with a display device, which is comprised of at least one display face, which in one embodiment is slanted, at least one communication device, and at least one movement apparatus, wherein the movement apparatus imparts movement to the communication device in relation to the display face depending on the communication from the gaming device to the display device. The movement can be multi-dimension movement such as two-dimensional movement. The movement apparatus can be a single actuator, a drive mechanism, which is a plurality of actuators acting in concert to provide communication device movement, or the like. The motion provided by the actuator(s) can be based on threaded shaft, rack and pinion, movable belt, solenoid, and the like.

### CROSS REFERENCE TO RELATED APPLICATIONS

The present application claims priority of and incorporates by reference U.S. provisional patent application Ser. No. 60/503,308, entitled METHOD AND APPARATUS FOR GAMING, filed Sep. 15, 2003.

### FIELD OF THE INVENTION

The present invention relates generally to actuators for gaming devices, namely actuators that provide physical movement.

### BACKGROUND

The spread and growth of the gaming industry has been marked by a generally corresponding growth in competition between the gambling establishments. To distinguish one another during the scramble to attract new gaming players while retaining the loyalty of established players, the gaming establishments have created a demand for gaming devices that provide greater stimulating and exciting play over prior gaming devices. To meet this need, the purveyors of such gaming devices have put forth gaming devices that can be associated with display devices, which are capable of multiple level sensory stimulation. This multiple sensory stimulation has been found to be particularly effective at both attracting new customers while retaining the loyalty of established players.

Generally, to provide this multiple level sensory stimulation, a display device may utilize at least one communication device (e.g. a movable indicator, which moves along a pathway; a display, which features some motion not otherwise involving a movement along a pathway, and the like). The display device may use at least one movement apparatus to impart some form of motion, movement or the like to at least one communication device associated with the display device. The movement apparatus, itself may be comprised of at least one actuator or a set of actuators acting in concert (e.g., a drive mechanism), which actually provide the movement or motion. The actuator can be comprised of at least one propulsion device (e.g., a motor) and at least one mechanical device, which converts the movement of the propulsion device into a movement, which may be used to propel or otherwise put a communication device into motion in some fashion. A control system (e.g., a controller) may used in conjunction with the actuator(s) to govern the activity of the actuator(s) and hence the activity of the communication device(s) as it relates to the activities of any device or implement (e.g., the gaming device), which is in some form of communication or association with at least one display device.

It appears therefore, as demand generally grows in the gaming industry for new types of gaming devices having display devices utilizing motion or movement, there is an essentially corresponding need to provide new types of movement apparatuses (e.g. actuators, drive mechanisms, and the like), which may provide and otherwise impart new and exciting movement, motion and the like to those communication devices, which may be used in display devices that may be associated with gaming devices.

### SUMMARY OF ONE EMBODIMENT OF THE INVENTION

### ADVANTAGES OF ONE OR MORE EMBODIMENTS OF THE PRESENT INVENTION

The various embodiments of the present invention may, but do not necessarily, achieve one or more of the following advantages:
the ability to provide visual content that excites and stimulates player during operation of the gaming device;
the ability to indicate game outcomes, such as prizes, with moveable indicators;
the ability to provide an entertaining moveable indicator;
the ability to move an indicator while meeting various movement and structural requirements;
the ability to foster anticipation to encourage continued playing of the gaming device;
the ability to communicate with the player(s) on various operational aspects of the gaming device;
the ability to provide a level of interest to the player that increases the player retention and brand loyalty;
the ability to provide the player with a clear concise transmission of gaming information regarding the operations of the gaming device;
the ability to attract new players to gaming by providing sensory stimulating communications and easy-to-comprehend information regarding the operations of the gaming device; and
to provide for the potential of increased profitability in the operation of gaming devices featuring movable actuators.

These and other advantages may be realized by reference to the remaining portions of the specification, claims, and abstract.

### BRIEF DESCRIPTION OF ONE EMBODIMENT OF THE PRESENT INVENTION

One embodiment of the invention could be an actuator comprising, at least one propulsion device, which is in rotatable contact with at least one threaded shaft; and the threads of the threaded shaft are moveably received by a threaded portion of at least one communication device; wherein the rotation of the threaded shaft provides movement to the communication device along a pathway which is located proximate to a display face of a display device which is in communication with a gaming device.

One embodiment could be an actuator comprising, at least one propulsion device that is in rotatable contact with at least one pinion; the pinion which moveably engages at least one rack; and the rack, which is in association with at least one communication device, providing movement to the communication device in relation to at least one display face of a display device that is associated with a gaming device.

One embodiment could be a gaming device comprising, at least one gaming device configured to allow at least one player to play at least one game, the gaming device is in communication with at least one display device; the display device defined by having at least one display face, at least one communication device in communication with at least one movement apparatus located proximate to the display face, the movement apparatus further providing the communication device with movement in relation at least one pathway located proximate to the display face; wherein the movement apparatus provides multi-dimensional movement to the communication device along the pathway.

One embodiment could be a gaming device, comprising, a gaming device, which allows at least one player to play at least one game, is comprised of least one controller system, which can at least in part govern at least part of the operation of the display device; a display device which is associated with the gaming device, the display device comprising of at least a slanted display face, at least one communication device, and at least a movement apparatus; wherein the movement apparatus is associated with the communication device to impart movement to the said communication device relative to the slanted display face.

One embodiment could be a gaming device comprising, a gaming means whereby one or more players may play at least one game; a display device means associated with the gaming means comprising of at least one display face means, at least one communication means, and at least one movement apparatus means, wherein at least one communication device means is associated with at least one movement apparatus means which is capable of imparting multi-directional movement to the communication device means relative to the display face means.

One embodiment could be a method of operating a gaming device, comprising, but not all necessarily in the order shown, providing a gaming device which allows at least one player to play at least one game; providing a display device in communication with the gaming device, the display device providing at least one display face, at least one communication device and at least one movement apparatus; wherein the movement apparatus provides to the communication device relative to the display face a motion that is based on a movement of a threaded means; initiating the operation of at least one movement apparatus to provide movement to at least one communication device to preset parameters; taking in player information; deciding whether a win occurred; initiating the operation of at least one movement apparatus to provide movement of at least one communication device to predetermined parameters based upon the decision of whether a win had occurred.

The above description sets forth, rather broadly, a summary of at least one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective frontal view of one embodiment of a gaming device of the present invention.

FIG. 2 is substantially a side elevation view of one embodiment of a display device of the present invention.

FIG. 3A is substantially a side elevation view of one embodiment of a display device of the present invention.

FIG. 3B is substantially a side cross-section view of one embodiment of a movable indicator.

FIG. 3C is substantially a frontal cross-section view of one embodiment of a movable indicator.

FIG. 4 is substantially a side elevation cutaway view of one embodiment of a display device of the present invention.

FIG. 4A is substantially a side elevation cutaway view of one embodiment of a display device of the present invention

FIG. 5 is substantially a perspective view of one embodiment of a display device of the present invention.

FIG. 6 is substantially a frontal elevation cutaway view of one embodiment of a display device of the present invention utilizing at least one drive mechanism.

FIG. 7 is substantially a frontal elevation cutaway view of one embodiment of a gaming display of the present invention utilizing at least one drive mechanism.

FIG. 8 is substantially a flow chart for one possible embodiment for the operation of the invention.

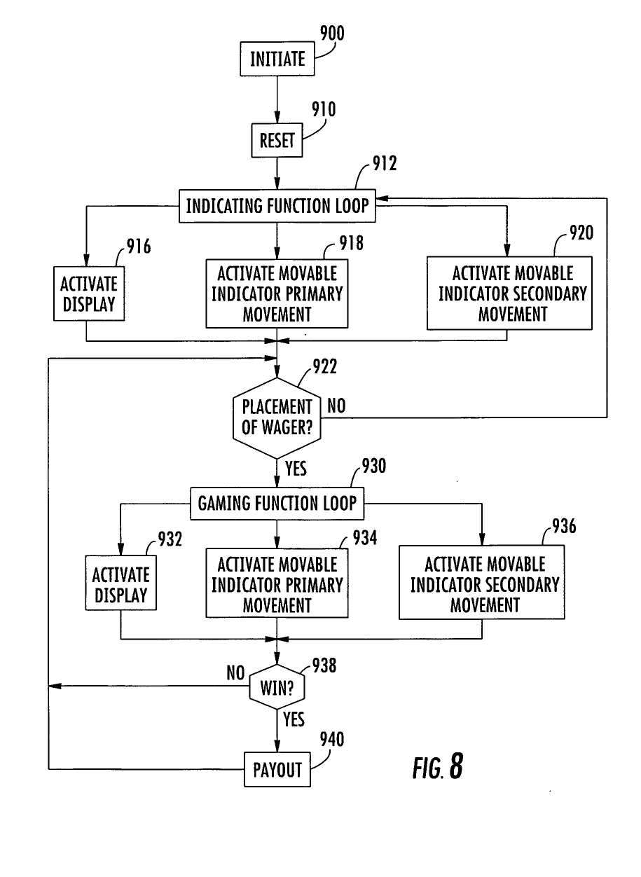

### DESCRIPTION OF CERTAIN EMBODIMENTS OF THE PRESENT INVENTION

In the following detailed description of certain embodiments of the present invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

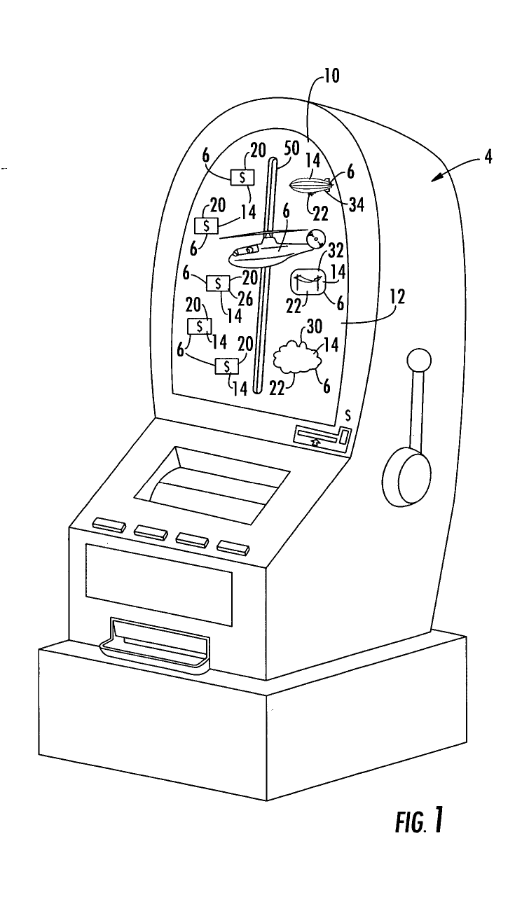

As shown in FIG. 1, the invention, in at least one embodiment, will generally be in communion with a gaming device, generally denoted by reference numeral 4. The gaming device 4 may be a primary gaming device and/or a supplementary gaming device (bonus game) that may be used in the gaming or entertainment industries to allow a player(s) to generally play a game. Such gaming devices 4 may include, but are not limited to, the following: electronic video games; gambling machines; video poker machines; machines that may receive/payout a player's wager/bet; and any other gaming device that may exist in the future. In at least one embodiment of the invention, the gaming device 4 may be one that could allow a player to place a wager or bet on a game or event. In at least one embodiment of the invention, the gaming device 4 (e.g., a slot machine) could allow a player(s) to place a wager or gamble as well as play a game.

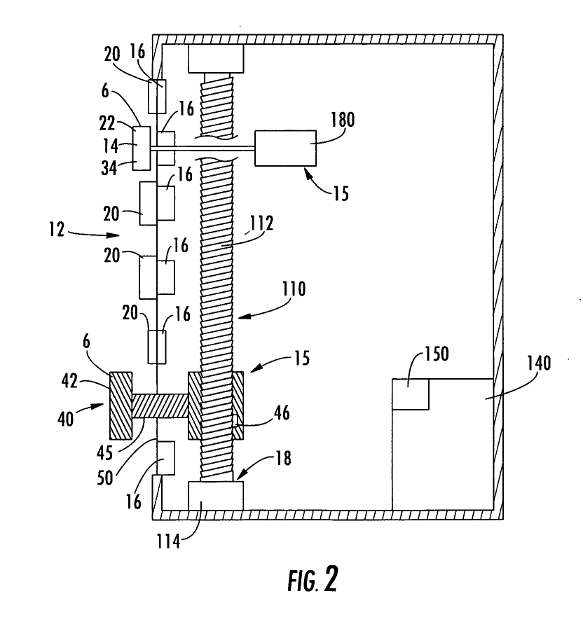

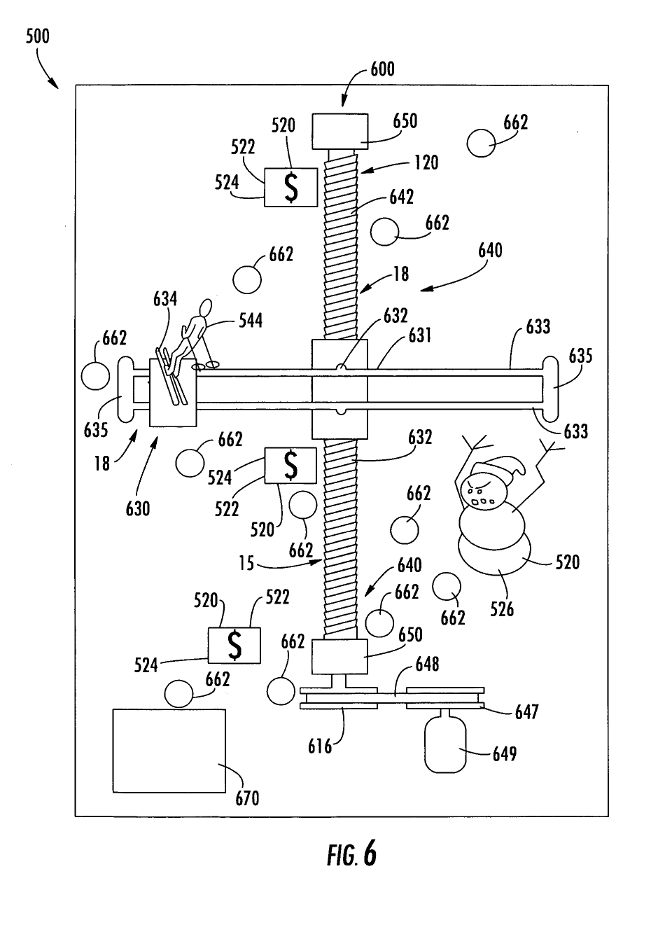

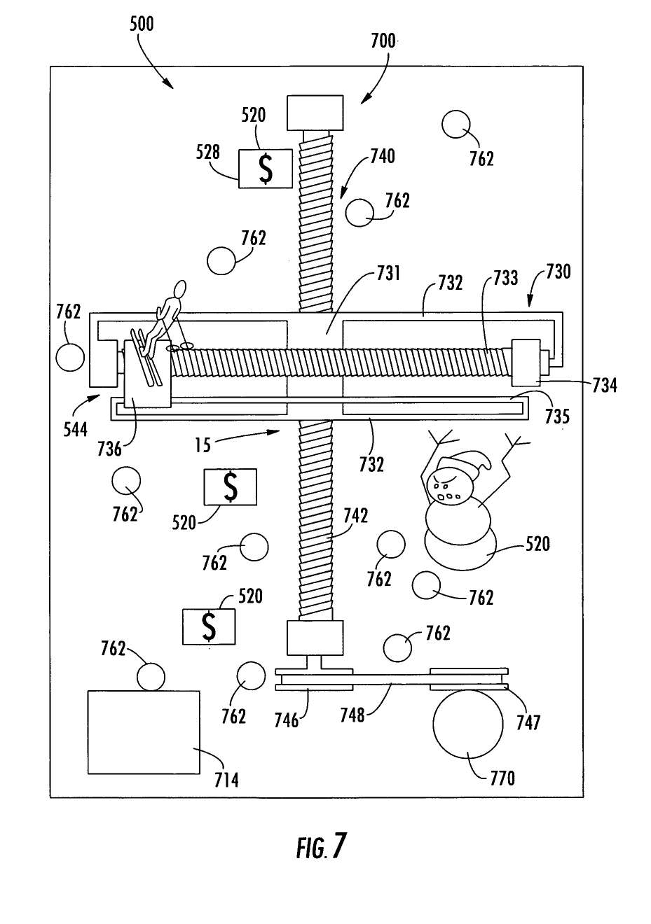

As shown essentially in FIGS. 1 and 2, one possible embodiment of the invention may comprise of at least one gaming device 4 (e.g. slot machine), in communication with a display device 10. The display device 10 may be generally defined by at least one display face 12, which is in communication or otherwise associated with at least one communication device 6 (e.g. a movable indicator 40, a display 14, or the like). At least one communication device 6 may be associated with one movement apparatus, generally denoted by reference numeral 15. The movement apparatus 15 may impart some form of motion, movement or the like to communication device. The movement apparatus 15, itself may be comprised of at least one actuator 18 or a plurality of actuators 18 acting in concert (e.g., a drive mechanism 17 as shown in FIGS. 6 and 7), which actually provides the movement or motion for the movement apparatus 15.

The actuator 18 can be comprised of at least one propulsion device (e.g., a motor) 114 and at least one mechanical device (e.g. a rack and pinion, a threaded shaft or the like) that converts the movement of the propulsion device 114 into a movement that may be used to propel or put into motion in some fashion, the communication device 6. A control system (e.g., a controller 140) may used in conjunction with the actuator(s) 18 to govern the activity of the actuator(s) 18 (and hence the activity of the communication device[s] 6) in relation to other activities of any device or implement (e.g., the gaming device 4), which is utilizing, incorporating or otherwise in some form of communication with at least one display device 10.

The display face 12 may generally be further defined by a front surface and a rear surface (or underneath portion). One or more of the surfaces may in part be defined by having at least one pathway defining at least a portion of the movement for at least one moveable indicator 40. In at least one embodiment, the pathway is an aperture, a slot 50, through which at least a portion of the moveable indicator 40 passes. In this manner, the moveable indicator 40 may be able to connect to the movement apparatus 15, which is being used to at least propel the movable indicator 40 along at least a portion of the slot 50.

The display face 12 may be generally further defined by at least a second communication device 6 (e.g., a display 14), which is positioned relative to at least one stop position 16. The number of display faces 12, movable indicators 40, displays 14, stop positions 16, slots 50, actuators 18, and controllers 140 that may be employed by the invention generally depends on the particular design needs and operation protocols for a particular application (e.g. gaming device 4).

In the present embodiment, the travel pathway may be defined by at least one aperture, a slot 50, through which at least a portion of at least one movable indicator 40 can moveably pass through the display face 12 to communicate with at least one actuator 18. The slot 50 may be linearly shaped and placed in a generally vertical orientation upon the display face 12.

Movable indicator 40 may comprise at least an indicator display 42 which is attached to one end of a bracket 45 that has a nut 46 (or other threaded device) affixed to its other end. A portion of the bracket 45 passes through the slot 50 to the underside of the display face 12 to generally connect the nut 46, and hence the movable indicator 40, to at least one actuator 18, which is located generally underneath or behind the gaming display face 12.

The display device 10 may be activated, triggered or otherwise controlled by at least one gaming device 4 (either a primary or a supplementary gaming device or both) to essentially communicate or otherwise generally disseminate various information. In at least one embodiment, such information could relate to gaming activities, for example: the awarding of prizes; the termination of an immediate and/or bonus game event; or other gaming action on the occurrence of a pre-defined event(s) occurring in a game.

When the gaming device 4 essentially informs the player, through the gaming display 10, that a gaming-activated or gaming-based event has occurred, a movement apparatus 15 may be activated, so as to generally impart motion, movement or the like to at least one communication device 6. In at least one version of the embodiment, the communication device maybe a movable indicator 40 which moves relative to pathway such as the slot 50.

In at least one version of the present embodiment, as shown in FIGS. 1 and 2, the display device 10 has at least one communication device 6, a movable indicator 40, which shaped in the representation of a helicopter (in either two or three dimensional form). Upon the occurrences of predetermined event, at least one actuator 18 will essentially propel the movable indicator along at least portion of the generally vertically orientated length of the slot 50. In at least one version of the present embodiment, the gaming device 4, the display device 10 or both, can be programmed to have the movable indicator 40, when in motion, to eventually stop at least one position stop(s) 16, of a set of position stops 16 located in relative proximity to the slot 50.

In the present embodiment, each position stop 16 could have at least one corresponding display 14 to form a least one position stop 16/display 14 set. Several of these sets could be divided into multiple groups, with each group being assigned to generally communicate a specific category of information. In at least one version, all the position stop 16/display 14 sets of the display face 12 are assigned to generally communicate a specific category of information. In at least one version, the displays 14 may further bear some indicia, design or the like to communicate a specific category of information (e.g., gaming information) upon its selection or activation.

In the present embodiment, one group of stop position 16/display 14 sets may be associated with award notification information (e.g., the displays 20 have indicia of dollars signs to indicate a winning wager). A second group of stop position 16/display 14 sets may be associated with game-terminating notification information (e.g., displays 22 are shaped like a blimp display 34, power line display 32, cloud display 30, etc.). Displays 22 may communicate that the immediate game has ended or terminated through the symbolism of a crash or other grounding of the helicopter as represented when movable indicator 40 shaped like a helicopter is aligned, for example, with cloud display 30).

The various embodiments of the invention could have the communication devices (e.g., moveable indicators 40, displays 14 and the like) utilize a wide variety of communication methodologies. These methodologies could incorporate any appropriate means such as, but not be limited to, visual means (including but not limited to indicia, graphic, three-dimensional depictions and the like); and/or auditory means (including but not limited to lighting effects, darkening effects, color differentiation and the like) and/or tactile means (including but not limited to vibration, changes in surface texture and the like) as limited only by the imagination of the game designers and needs/criteria of the gaming device 4. For example, the communication devices 6 may incorporate LED meters, CRT screens, LCD screens, etc. The communication devices could incorporate one or more such methodologies simultaneously to essentially communicate information on several levels.

Single Actuators

As shown in FIG. 2, one possible embodiment of the actuator 18, which may be located beneath the display face 12, could be a threaded shaft actuator 110. The threaded shaft actuator 110 may employ a propulsion device 114 (e.g., an electric motor), a threaded shaft 112, a two-ended bracket 45, which is attached at one end to the movable indicator 40 and attached at the other end to a nut 46 (or other threaded device). The propulsion device 114, which is may be governed by at least one controller 140, generally rotates the threaded shaft 112 about its longitudinal axis. The threads of the threaded shaft 112 essentially movably engage the threads of the nut 44 attached to the bracket 45. As a result, as the threaded shaft generally rotates, the nut 46, bracket 45 and the movable indicator 40 attached the bracket 45 can be propelled along at least a portion of the length of the threaded shaft 112. This single actuator's 110 action generally provides two dimensional movement of the communication means 10 along an x and y axis.

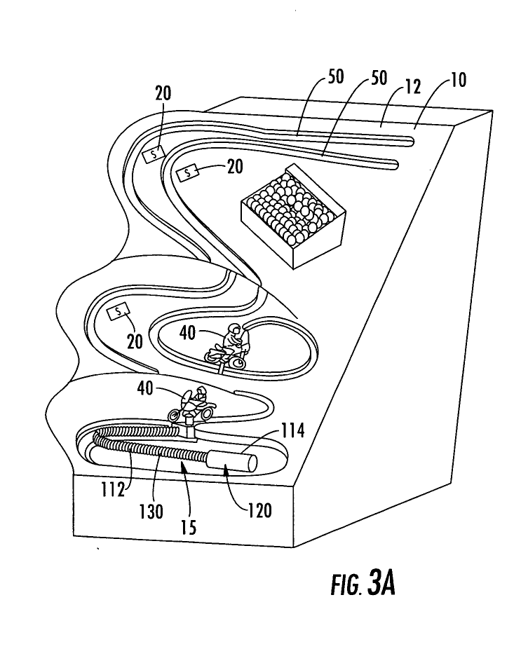

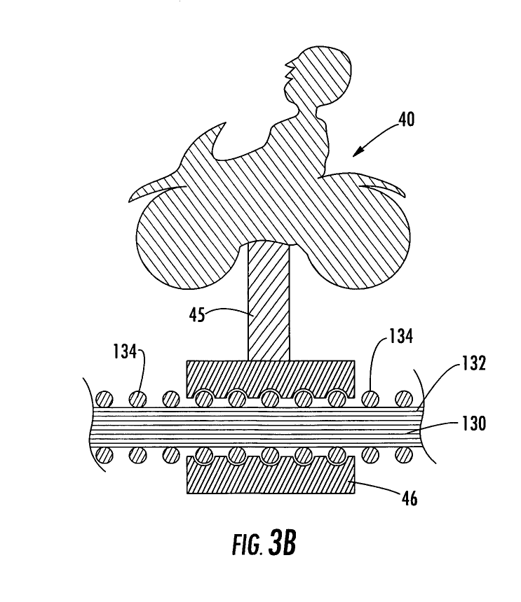

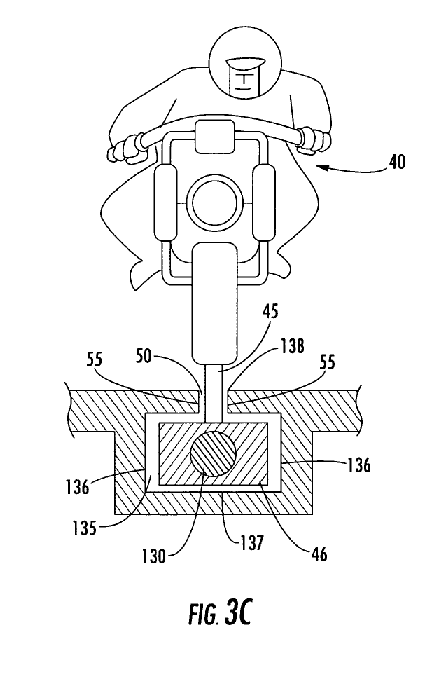

To provide three dimensional movement of the communication device 6 along an x, y and z axis, another embodiment of the invention uses a threaded shaft actuator 110, as generally discussed above, with the exception that the threaded shaft 112 is substantially flexible. FIGS. 3A, 3B, and 3C essentially show one embodiment of a display device 10 and communication device 6 (e.g., a movable indicator 40), which uses a flexible threaded shaft actuator 120. The flexibility of the flexible threaded shaft 130 not only allows the pathway (e.g. slot 50) of the communication device 6 (e.g., movable indicator 40) to essentially incorporate a wide variety and degrees of geometric intricacy, but generally allows a gaming display face 12 to have three-dimensional features and to have at least one communication device pathway, which can follow at least a portion of one or more of those three-dimensional features. In this manner, an movable indicator 40, for example, in a shape representing a skier, motorcyclist or the like, could be propelled through, along or onto three-dimensional features of the gaming display surface 12 such as projections (e.g., three-dimensional depictions of mountains) and/or depressions (e.g., three dimensional representations of valleys) and the like.

Flexibility of the flexible threaded shaft 130 can be provided by using a variety of means known in the art or that will become known to the art in the future. One such means that could be employed is to essentially have the flexible threaded shaft 130 made singularly from flexible material such as an elastomer.

Another possible means of providing flexibility is to essentially have the flexible threaded shaft 130 be constructed from multiple flexible components. In this manner, the flexible threaded shaft 103 could have a flexible core 132 (e.g., made from a cable, wire, spring or the like) around which a flexible thread 134 (e.g. an additional cable, wire or the like) is spirally wrapped. In this fashion, the flexible thread 134 could provide a threaded surface (e.g., spiral groves), which can rotateably engage the threads of the nut 46 (or other suitably threaded device) that is attached to the bracket 45. In this manner, the rotation of the flexible threaded shaft 130 can then generally move the bracket 45 and the movable indicator 40 (which is generally attached to the bracket 45) along the pathway.

In construction of the flexible threaded shaft 130, it should be noted that when the flexible threaded shaft 130 is bent, the threads of the flexible thread shaft 130 could move closer together on the in side of the bent flexible threaded shaft 130 and spread further apart on the other side of the affected shaft area. Using knowledge known to those skilled in the art, the design of the threads (height, pitch, TPI count, etc.) of the flexible thread shaft 130 and the nut 46 (and other dimensions of the invention) should include those tolerances, which could allow for the non-binding of flexible threaded shaft 130 when rotating within the threads of the nut 46 (or other suitable threaded device) during operation of the invention.

In order to possibly further facilitate the movement of the communication device 6 (e.g., movable indictor 40) by a flexible threaded shaft actuator 130, the flexible threaded shaft 130 could set in a open channel 135, which could be comprised of enclosed sides 136, an enclosed bottom 137, an open top 138, and at least one open end (not shown). The open channel 135 could be located below the display face 12 so that the open top 138 forms the slot 50. The open end (not shown) could allow at least one end of the flexible threaded shaft 130 to connect at one end to a propulsion device 114 (e.g., a motor), which is used generally to axially rotate the flexible threaded shaft 130. The open channel 135 should be of sufficient width and depth to essentially freely accommodate the nut 46 and nut end of the bracket 45 of the movable indicator 40; to essentially prevent the rotation of the bracket 116 when the flexible threaded shaft 130 rotates; to allow essentially the free and unbinding rotation of the flexible threaded shaft 130 during the propulsion of the movable indicator 40; and to generally hold the flexible threaded shaft 130 within the confides of the open channel 135.

One possible embodiment of the flexible threaded shaft actuator 120 is essentially depicted in FIGS. 3A, 3B and 3C, wherein at least one flexible threaded shaft-based actuator 110 generally propels at least one motorcycle-shaped movable indicator 40 along a pathway (e.g. slot 50, open top 138), which could have one or more curves, spirals, loops and the like, generally laid over one or more three-dimensional contours (e.g., projection, depressions and the like) on the display face 12. Such contours in at least one version could represent hilly landscapes.

Due to the compact and flexible nature of this flexible threaded shaft actuator 120 embodiment, it could be foreseeable that multiple flexible threaded shaft-based game actuators 120 could be combined on a single display device 10. In at least one version, it could be possible that the pathways for the multiple flexible threaded shaft-based game actuators 120 could possible have a substantially parallel (or non-parallel) orientation (e.g. such as to generally emulate a motorcycle race).

In addition to the physical connection means between movable indicator 40 and actuator 18 as described above, other embodiments of the invention could provide for the movement of a movable indicator 40 that is not in direct physical communication with the actuator 18. These embodiments of the invention would utilize magnetic attraction whereby a magnet (not shown) located in the communication device 6 located above the display face 12 would be attracted to a corresponding secondary magnet (not shown) attached to the actuator 18 located below the display face 12. Thus, the magnetic attraction could force the communication device to follow on the top of the display face 12 the pathway below the display face 12 as taken by the moving part of the actuator containing the secondary magnet. This movement would be very similar in manner and operation of music boxes which featured the illusion of rotating figurines of dancers/skaters apparently gliding about on their own power upon the mirrored top of the music box. These means of non-direct communication between communication device(s) 6 and actuator(s) 18, which lack a fixed pathway (e.g., a slot 50), could allow for the creation of at least one pathway on the display device 10 which could be changed during the operation of the invention.

In at least one possible embodiment, one or more of the displays 14 could also be given movement by the actuator 18, such as a solenoid-based actuator 180, which is shown in FIG. 2. The solenoid-based actuator 180 could be located behind the display face 12 and is connected to a portion of display 22, which moves relative to the solenoid actuator 180 through an aperture in the display face 12. The movement imparted by the solenoid-based actuator 180 to the attached display 14 could include, but not be limited to, moving the display 22 closer to; away from; through the gaming display face 12 (not shown) or any combination thereof. The movement of solenoid-based actuator 180 would be controlled by controller 140 or any other control system known to the art or yet to be developed in the art.

In the present embodiment, as an example and with reference to FIGS. 1 and 2, when a controller 140, in generally determining that game-terminating event has occurred, could cause (e.g., via a threaded shaft actuator 110, flexible threaded shaft actuator 120 or other actuators 18) a movable indicator 40 (e.g., shaped-like a helicopter) during its travels along the pathway (e.g., the slot 50) to finally come to rest at the stop position 16, which is associated with a display 14 (e.g., a player game-terminating notification display 34 having a form of a blimp). At that time, the controller 114 could also activate a solenoid-based actuator 180 to essentially move the blimp-shaped display 34 from a position of close proximity to the front surface of the display face 12, to a position that is more outward and distant. Alternately, the above action could be the display 14 repeatedly moving back and forth from the front surface of the display face 12. The visual effect of these actions could essentially communicate the impression that a game-terminating notification display 34 (the blimp) has interfered with the upward motion of movable indicator 40 (the helicopter), therefore essentially denoting aircraft collision signaling the termination of a game, bonus game, betting/wagering or other such event. When invention generally causes the movable indictor 40 to moves onto another stop position 16, the display 34 could be reset to the display's original “inactive” position proximate to the front surface of the display face 12.

Similarly, in at least one version of the present embodiment, at least one actuator (e.g., a solenoid-based actuator 180) can also be used for generally providing movement of at least one award notification display 20 to essentially communicate various information (e.g. that a prize(s) is to be awarded a player). As generally outline above, the controller 140, in determining that a player is entitled to a prize, could cause the moving indicator 40 to stop at a stop position 16 that is adjacent to an award notification display 20. At that time, the actuator 18 (not shown) in communication with the award notification display 20 could cause the movement of the award notification display 20 (e.g., moving the display away from the top surface of the display face 12; moving back and forth relative to the top surface of the display face 12; vibrating the display and the like, or various combinations thereof) to essentially communicate information (e.g., the awarding of a prize won by a player) and generally enhance the excitement of the prize-winning atmosphere.

As denoted generally above, the invention has at least one controller 140, which is used to control various aspects of the activities of the actuators 18. The controller 140 may act in conjunction with a plurality of sensors 162 to allow the controller 140 (or any other control or governance system(s) (not shown) known to the art or will be known to the art in the future), to detect the primary movement position of movable indicator 40. Further, in at least one embodiment of the invention, the controller 140 may receive input from a random number generator 150 (or pseudo-random number generator) for use in the determining of an event that requires communication through the movement of a communication device 12; the creation of award amounts in conjunction with a payout table and the like.

Once controller 140 determines that at least one communication (e.g., to at least one player) is required, the controller 140 causes the appropriate display (e.g. coordinated movement of one or more communication devices 12) to occur.

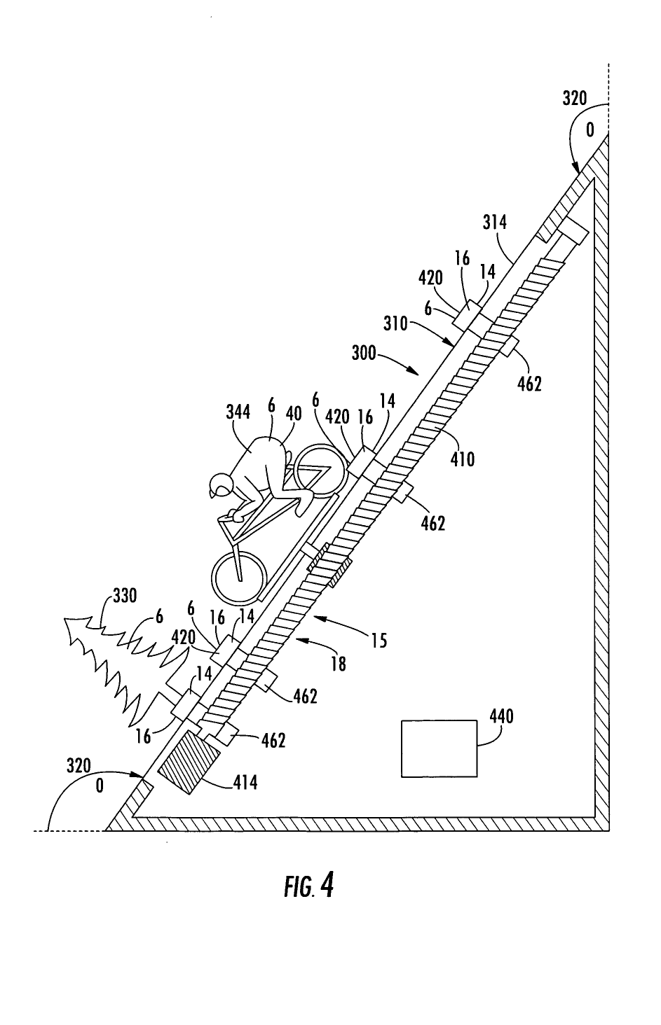

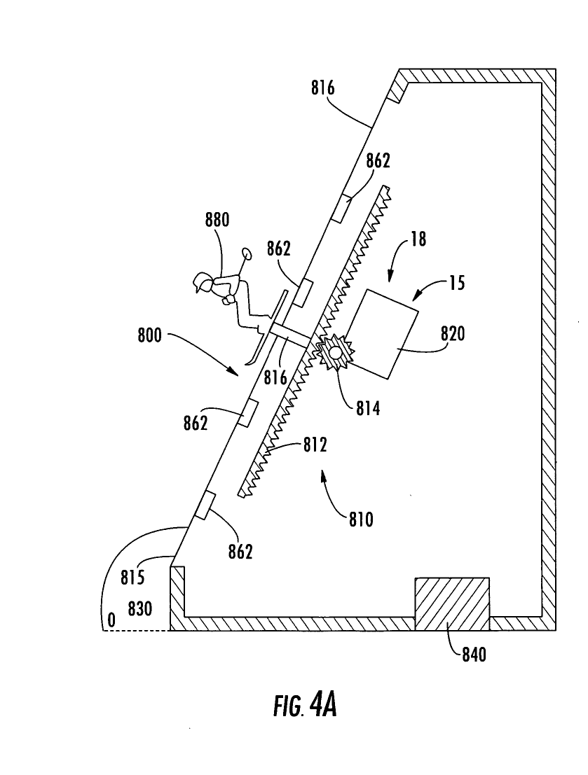

FIG. 4 is substantially a side-view cutaway of another embodiment of the invention with a display device generally indicated by reference numeral 300. This embodiment is substantially similar to that depicted in FIG. 1 with at least one difference being that the display device 300 has an angled display face 310 that is generally positioned at a display face angle 320 other than generally vertical. The display face angle 320 can be compared with either a vertical angle of a wall for a wall mounted embodiment of the invention or the horizontal angle of ground for ground mounted embodiments of the inventions. The slanted or angled orientation of display face 310 may allow the creation of a display device 300 which will be unique and provide enhanced enjoyment to players. The non-limiting example that is depicted in FIG. 3 will operate in a manner virtually identical to that of FIGS. 1 and 2, but the movement and placement of the communication devices 6 and actuators 420 will occur at a different angle.

The display device 300 in this embodiment could have movable indicator 344, generally depicted as a downhill bicyclist, moving along the length of at least one linearly shaped pathway (e.g., slot 314). The pathway could have a generally vertical orientation with respect to the display face 310 upon which it is located. As discussed-above for other embodiments, a plurality of stop positions 16 could be associated with respective displays 14 to form sets of stop positions 16 and displays 14, which are essentially located proximate to the pathway. The displays 14 could also be comprised of award notification displays 420 and game-terminating notification displays 330. In at least one possible version, the award notification displays 420 could have dollar sign indicia while the game-terminating notification display 330 could have a three-dimensional form representing a tree.

To generally effect communication of information (e.g., such as an awarding of a prize), the movable indicator 344 appears in FIG. 4 be located in proximate relationship at a stop position 16 (not shown) associated with an award notification display (not shown). Alternately, the gaming display 300 may communicate the end of play by locating a moving movable indicator 344 at a stop position 16 that is in close proximity to the game-terminating notification display 330. This action would communicate the impression of having the bicyclist form coming into contact with the tree form. As discussed earlier, many other shapes, objects, actions and combination thereof, may be used for communication information (via award notification and game termination displays 420, 330, respectively and the moveable indicator(s) 344, 40 respectively). As discussed in relation to FIG. 2, the displays 420, 330 in this embodiment could be further provided with actuator generated movement (e.g., solenoid-actuator 180 [not shown in FIG. 4]).

As shown generally in FIG. 4, a movable indicator 344 may be propelled (e.g., moved up and down the slot 314) by an actuator 18 (e.g., a threaded shaft actuator 110, flexible threaded shaft actuator 120 or the like). A plurality of sensors 462 may also be provided to allow controller 440, or any other control mechanism (not shown), to essentially detect the position of at least movable indicator 344 and to generally control the actions of at lest one actuator 18 for the movable indicator 344, accordingly.

Although the display face angle 320 (in at least one embodiment is forty-five degree angle) and design (e.g., linear) of the pathway (e.g. slot 314) essentially confines the movement of the movable indicator 344 to linear movement at a forty-five degree angle, other movements (direction, angle, orientation, etc.) for the moveable indicator 344 are possible based on the apparatuses and methodologies disclosed within.

The method by which prizes are awarded, games are terminated, or other game-related events are caused to occur in relation to the present embodiment could utilize those apparatuses, means and methodologies that have previously been discussed with reference to FIGS. 1 and 2.

FIG. 4A is substantially a side view of an alternative embodiment of display device, generally denoted by reference numeral 800, which could comprise of at least one display face 815, an actuator 18, specially a rack and pinion actuator, generally denoted by reference numeral 810, and at least one movable indicator 880 (which is shaped like a skier), wherein the rack and pinion actuator 810 generally propels the movable indicator 880 along at least a portion of at least one pathway (e.g. slot 816) which is located to the display face 815.

The rack and pinion actuator 810 may be comprised of a propulsion device 820 (e.g., motor), pinion gear 814, and a rack 812. Activating the rack and pinion actuator 810 essentially causes the propulsion device 820, which is essentially connected to the pinion gear 814, to generally rotate or otherwise turn the pinion gear 814. The teeth of the pinion gear 814 then essentially movable engage the respective teeth of the rack 812, which is generally attached, associated or otherwise in communication with the movable indicator 880. When the pinion gear 814 essentially rotates, it generally causes the rack 812, which the moveable indicator 880 is essentially attached, to respectively move away from or towards the pinion gear 814 to thereby propel the movable indicator 880 along at least a portion of at least one pathway (e.g., slot 816) with which the movable indicator 880 is generally associated.

As disclosed above with other embodiments of the threaded shaft actuator 110, at least one embodiment of the rack and pinion actuator 810 can have one its components (e.g., the rack 812) be made from either flexible or non-flexible material. A non-flexible version of the rack 812 may limit a rack and pinion actuator 810 as to the type of movement that it can provide for the communication device 6. A flexible version of rack 812 can be inserted in an open channel (not shown) located below the gaming display face 12, wherein the open channel can be positioned as a pathway (e.g., slot 816) having a wide variety of geometric shapes. Additionally, the flexible version of the rack 812 can be attached at both ends to provide a closed loop. In this manner, the rack and pinion actuator 810 can provide continuous travel for the associated movable indicator(s) along a looped pathway (not shown).

The movable indicator 880 can be associated with the rack 812 through any one of multitude of the means known to those skilled in the art to will readily become known in the future. This would include, but not be limited to the directed physical connection (e.g., bracket/nut means) indirect non-physical connection (magnetic means of connection) as discussed above.

As more fully discussed above, display(s) 14, stop position(s) 16, (neither shown in FIG. 4A) as well as controller(s) 840 and sensors 862 could be used in this embodiment for general communication of the positioning of communication devices 6 (e.g., movable indicator 880) as well as the general control of the rack and pinion actuator(s) 810 and other actuators 18 which may be used. Also the display face 816, as discussed above could have a display face angle 830 which is at an angle other that generally vertical (e.g., more or less that perpendicular to the ground reference where the invention is located).

Combined Actuators

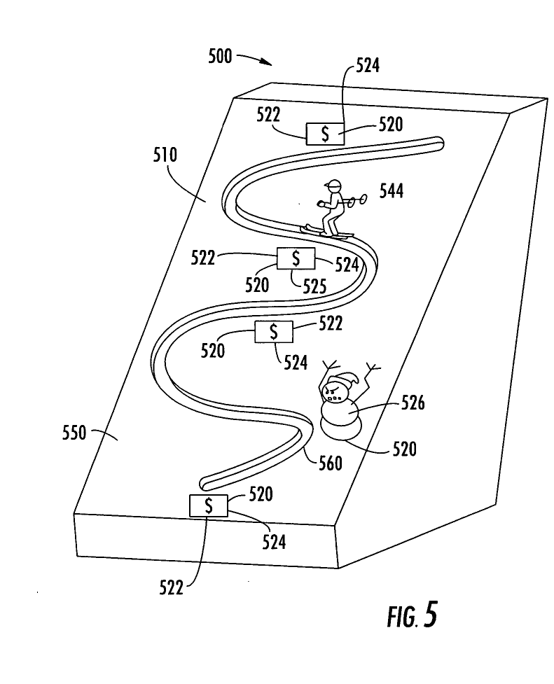

FIGS. 5, 6 and 7 generally reference several embodiments of the inventions wherein the display devices rely upon a plurality of actuators 18 combined together and acting in concert to generally provide a two-dimensional movement along an x and y axis for at least one movable indicator 544 along at least one pathway located on the display face 510 of a display device, generally denoted by reference numeral 500.

FIG. 5 essentially shows one embodiment of the invention wherein the display device 500 essentially has an angled display face 510 (the aspects of which have discussed above) with at least one pathway (e.g. a slot 560). Along the pattern of the pathway, moves a movable indicator 544, which is configured to represent a downhill skier. The slot 560 in at least one embodiment is constructed to have a pattern (i.e., zigzag) that has non-linear components such as curves, loops, spirals and the like. In at least one embodiment, the pathway further incorporates the non-linear elements with linear elements.

As with the other various embodiments of the invention, a plurality of sets of stop positions 520/displays 522 are generally located display face 510 relative to the pathway. Of the displays, three could be award notification displays 524 while one could be a game terminating notification display 526 (e.g., a two or three dimensional form of a snowman).

As stated above for other embodiments of the invention, the communication of information (e.g., the awarding of a prize to a player) could be communicated by having movable indicator 544 to appear to have stopped at a stop position 520 associated with an award notification display 525 (which appears to show the indicia of dollar signs). As stated-above for the communication of information for game termination, the movable indicator 544 could be stopped at the stop position 520 adjacent to the game termination display 520 to indicate collision by the moveable indicator figure and the game termination display FIG. 520. In at least one embodiment, the a game terminating display FIG. 520 (e.g., the snowman figure display 526) could be moved by an actuator 18 (not shown) when the movable indicator 544 generally comes to rest proximate to the snowman to visually suggest a collision which essentially indicate that a game terminating event has occurred. As noted above, many other shapes, objects, actions and combinations thereof may be utilized by the display device 500.

FIGS. 6 and 7 are substantially front views of gaming display 500 from FIG. 5 with gaming device face 510 removed to show possible embodiments of the internal operation for gaming display 500. The internal operation for the movement of the movable indicator 544 along a pathway, which may contain non-linear elements, may include a drive mechanism comprised of several actuators 18 combined together and acting in concert, as generally indicated by reference numeral 600 in FIG. 6 and as generally indicated by reference numeral 700 in FIG. 7. These combined actuators 18 could have either the similar or different type of movement means. In at least one embodiment, one of these actuators 18 could impart to the connected movable indicator 544 a movement, which is different from the movements of the other combined actuators 18 of the drive mechanism 600.

On possible source for a drive mechanism 17, 600, 700 may be the Kerk Screw Rail Actuator™ as provide by the Kerk Motion Products, Inc., 1 Kerk Drive, Hollis, N.H., USA 03049. The Kerk Screw Rail Actuator™ can comprise a motor rotated precision rolled lead screw, supported by sealed bearings and contained within a concentric guide rail, driving an integrated nut bushing.

The drive mechanism 600, in at least one embodiment, could be comprised of at least two actuators 18 combined together, a first actuator, generally denoted by reference number 630 and second actuator, generally denoted by reference number 640. As generally depicted, the first actuator 630 is a sliding actuator wherein the second actuator 640 is a threaded-shaft actuator 120 as discussed above. In other versions, the first and second actuators, 630 and 640 respectively, could be joined with additional actuators 18 which provides a secondary movement to the moveable indicator 544 (e.g. vibration and the like).

In the presently discussed embodiment, the movable indicator 544 is affixed to the first actuator 630 which provides the movable indicator in at least one form of motion (e.g., horizontal movement). The first actuator 630 in turn is moveably connected itself to the second actuator 640 which provides the first actuator 630 and connected moveable indicator 544 with at least a second form of movement (or at least a second form of direction. In the present embodiment, the second form of movement is vertical movement).

Although not shown, an additional actuator of a type known in the art or which will be known to the art in the future, could be combined with the drive mechanism 600 to change the orientation or otherwise turn the movable indicator 544 so the front of the movable indicator 544 can always be facing the direction that it is being propelled in by the drive mechanism 600.

The first actuator 630 could be comprised of a base 631, pair of posts 632; a pair of railings 633, a sliding platform 634, and pair of bumpers 635. The base 631 could have a threaded bore (not shown) passing from one side of the base 631 to another side. This threaded bore could movable receive the rotating threaded shaft 642 of the second actuator 640. As the threads of threaded shaft 642 rotate within the threads of the threaded bore, the first actuator 630 and its attached moveable indicator 644 could be propelled along at least a portion of the threaded shaft 642.

The base 631 could have a pair of posts 632 located in a generally parallel configuration projecting outward from the top of the base 631. A railing 633 is attached to each of the non-base ends of the post pair 632. Each railing 633 is essentially attached to an end of a post 632 so as to generally orient railings 633 in parallel, planer relationship to one another. The railings 633 could be generally placed at a position far enough from the top of the base 631 so that the sliding platform 634 (to which at least one movable indicator 544 is attached) essentially clears the top of the base 631 and could run the full length of the rails 633 essentially unimpeded.

The sliding platform 634 could have in proximate vicinity to each of its two sides, a bore (not shown) or open channel (not shown) whose cross-section and diameter closely matches the cross-section and diameter of each of the railings 633 to generally allow each open channel/bore to freely receive a railing 633. In this manner, the sliding platform 634 is essentially moveable connected to railing pair 633 and can move up and down the length of the railing pair 633.

A movement means (not shown) in the sliding platform 634 comes in moveable contact with a portion of the rail pair 633 that is ensconced with the bore or open channels. Such a movement means could be comprised of powered wheel(s) connected to a motor or other propulsion apparatus. In this manner, the turning or rotating of the wheels could respectively draw the railings 633 into the bore or open channel of the sliding platform 634 essentially causing the sliding platform, and hence the attached movable FIG. 544, to move along the length of the railing pair 633.

Alternatively, the sliding platform 634 could be powered by a movement means (not shown) that is similar to those used in printers wherein an elastomeric band (not shown) attached to the sliding platform 634 which is moved by mechanical means (pulleys and a motor).

Alternatively, the sliding platform could be freely movable along the railings without being attached to an elastomeric band, motor or the like. In this manner, the slot 560 (e.g., having a zigzag shape) could force the sliding platform (and the attached moveable indicator 544) move (e.g., sideways) along the railings 633 as the second actuator 640 moves (e.g. up and down) the first actuator 630.

An anti-rotation device may be required to essentially inhibit the rotation of the first actuator 630/moveable indicator 544 around the second actuator 640 (e.g. the threaded shaft 642). Such an anti-rotation device could be the slot 560 (shown in FIG. 5). As discussed above, the slot 560 can limit the movement/direction of the movable indicator 544/attached second primary actuator 640. In additionally, or in substitution (i.e., for those embodiments which lack slots 560 since they use magnetic attraction to associate movable indicators 544 with actuators 18 or drive mechanisms 600), a plurality of polymer-based bumpers 635 can be employed as anti-rotation device. The polymer-based bumpers 635 can be placed at each end of the railings 633. The polymer-based bumpers 635 and the back surface of the display face 510 can be essentially constructed using methodologies and material known in the art or will be known in the art in the future so that the polymer-based bumpers 635 can ride along the back surface of the gaming display face 510 (with very little friction or interference) so as to prevent the unwanted rotation of the first actuator 630 and attached movable indicator 544 around the second actuator 640.

Another anti-rotation device could be a sleeve (not shown) that is fitted to the threaded shaft 642. The sleeve could have a longitudinal slot-shaped opening (not shown) through which a portion of the movable indicator 40 could pass through to moveably connect to the threaded shaft 642 of the second actuator 640. The interior of the sleeve should be of sufficient width and depth and other dimensions to essentially freely accommodate that portion of the sliding platform 632 that is in contact with the threaded shaft 642. At the same time, these dimensions could essentially prevent the unwanted rotation of the sliding platform 632 (and hence the first actuator 630) when the threaded shaft 642 rotates, as well as to allow the essentially free and unbinding rotation of the threaded shaft 642 during operation.

Other methods of preventing unwanted rotation known to the art or which will become known to the art may be used without departing from the scope of the present invention.

The second actuator 640 in the presently-described embodiment could be similar in construction to earlier-described embodiments of the threaded shaft actuator 120. In the presently described embodiment, the second actuator 640 may be held in place relative to the back of the gaming display face 510 by a pair of bushings or bearings 650. Each bushing or bearing 650 could be located at proximate end of the threaded shaft 642. Each bushing or bearing 650 may be attached to the back side of the gaming display face 12 so as to essentially locate and hold the threaded shaft 642 in proper orientation for efficient operations of the gaming display 500.

In one possible version of the second actuator 640, power could be supplied to the threaded shaft actuator 120 for the rotation of the threaded shaft 642 by essentially directly connecting a propulsion unit 649 (e.g., a motor) to one end of the threaded shaft 642. In at least one version, an indirect means of propulsion could be provided by having at least one primary pulley 646 essentially attached to at least one end of threaded shaft 642. The primary pulley could be linked to at least one second pulley 647 by at least one flexible member 648 (e.g., belt, chain, or the like). The second pulley 647 could be generally attached to a remotely located motor 649 which is then used to rotate the threaded shaft 642 through the above described linkage. A controller 670, connected to at least the first and second actuators 630, 640, respectively, could essentially govern the actions of at least one or more of these actuators.

It should be noted that while FIG. 6 generally depicts one possible orientation and setup for a drive mechanism 600, other embodiments (not shown) may have the first and second actuators 630, 640 in different orientation and angles than shown and that may provide further mechanisms that further provide for the changing or adjusting of said angles and orientations during the operations of the invention. This variance in physical relationship between the first and second actuators 630, 640 could be implemented by an additional actuator 18 (not shown) that could be used to effect a change the relationship between the first and second actuators 730, 740 based on various physical factors such as relative angle, distance, movement, speed of movement and/or other physical parameters of the drive mechanism 600.

If a slot 560 is used (e.g., when there is generally a direct mechanical connection between movable indicator 544 and the drive mechanism 600) in conjunction with the drive mechanism 600 then the slot 560 may be configured in a wide variety of designs to generally take advantage of the free-flowing multiple direction travel provided by the drive mechanism 600. To further facilitate the movable indicator 544 movement of along the slot 560 and to avoid damage to gaming display face 510 (and possibly other components of the invention), the edges of the slot 560 may be lined with various coatings such as with rubber, plastic or other low friction/elastic materials.

As discussed above with other embodiments of the inventions, a plurality of sensors 662 may be provided to essentially help the controller 670, or any other control methodology or mechanism (not shown), to detect the position of the movable indicator 544 along the pathway.

FIG. 7 is substantially a front view of gaming device 500 from FIG. 5 with display face 510 removed to reveal another possible embodiment for a drive mechanism, as denoted by reference numeral 700. This drive mechanism 700 could be comprised of a plurality of combined actuators 18 acting in concert to provide movement for at least one moveable indicator 544. The movement in this embodiment has the potential to provide complete two dimensional movement for the movable indicator 544 along x and y axis.

As generally shown in FIG. 7, one possible embodiment for the drive mechanism 700 could be comprised of a first actuator 730 (to which is attached the movable indicator 544), which is movably attached to a second actuator 740. As stated earlier for the embodiment depicted in FIG. 6, both first and second actuators 730 and 740 can be same or different types of actuators 18. Supplemental actuator(s) (not shown) may also be utilized, as described above, to provide supplemental movement to the movable indictor 544 (e.g., vibration, popup movement and the like).

As generally depicted in FIG. 7, the both first and second actuator 730, 740, respectively are essentially threaded shaft actuators as discussed above. The first actuator 730 could be comprised of a base 731, a pair of support rods 732, a first threaded shaft 733, a propulsion device (e.g., a motor) 734, an anti-rotation device 735, and a sliding platform 736. As described in detail above, the base 731 has a threaded bore (not shown) which can moveably receive the threads of a second threaded shaft 742 of the second actuator 740. The rotation of the second threaded shaft 742 causes the base 731 of the first actuator 730 (along with its attached moveable indicator 544) to move along at least a portion of the length of the second threaded shaft 742 of the second actuator 740.

Projecting outward from the top of the base 731 is a set of support rods 73 held in a generally parallel and planer relationship to one another. One support rod 732 holds the anti-rotation device 735 while the other support rod holds the first threaded shaft 742 and the propulsion device (which could be directly connected to one end of the first threaded shaft 742).

The support rod 732 holding the anti-rotation device 735 could have each end of the support rod connect to an end of the anti-rotation device 735. In the present embodiment, the anti rotation means 735 could be a bar, a portion of which is in essentially moveable contact with the underside of the display face 510. As noted above, other anti-rotation device may be substituted for or used in conjunction with the present anti-rotation device 735.

The second support rod 732 could be attached to the first threaded shaft 733 and propulsion device 734 by affixing one end of the supporting rod 732 to the propulsion device 734 and moveably affixing the other end of the supporting rod 732 to the non-propulsion device end of the first threaded shaft 733.

The pair of support rods 732 essentially lifts and supports the anti-rotation device 735, the primary threaded shaft 733, and the primary motor 734 generally away from the top of the base. This generally allows the sliding platform 736 (to which the movable indicator 544 is mounted) to essentially ride freely along at least a portion of the lengths of the first threaded shaft 733, and anti-rotation device 735 without substantial interference from the base 731.

The sliding platform 736, in order to allow it to slide, could have two bores (not shown) or two open channels (not shown) one of which is at least partially threaded to movably receive the threads of the primary threaded shaft 733. The other bore/open channel, which is not threaded, reversibly receives the anti-rotation device 735. As the primary threaded shaft 733 rotates, it causes the sliding platform 736 to move along at least a portion of the length of the first threaded shaft 733 and the anti-rotation device 735.

As noted above, the second actuator 740 moves the first actuator 730 along with its attached movable indicator 544. The second actuator 740, 640 has essentially the same format as shown in the embodiment of an actuator, which is essentially demonstrated in FIG. 6. This includes, but is not necessary limited to, the powering of the threaded shaft 742 by a propulsion device 770 (e.g. a remotely located motor). The propulsion device 770 is connected by a first pulley 746, flexible connection means 748 (e.g., a belt) and a second pulley 747.

At least one controller 714, in association with a series of sensors 762 for the detection of the moveable indicator's 544 position, may generally control the operation of the first and second actuators 730, 740 of the drive mechanism 700 during the operation of the invention.

One Methodology Of Operation

One embodiment of the invention's operation is generally depicted in the flow chart of FIG. 9. This operational embodiment has an initiate step 900, a reset step 910 and then two primary function loops, Indicating Function loop 922 which can lead into the Gaming Function loop 930.

The Indicating Function loop 912 has three sub functions: Activate Display 916, Activate Moving Indicator Primary Movement 918, and Activate Moving Indicator Supplemental Movement 920. These three subfunctions lead into Placement of Wager step 922. The Gaming Function Loop 930 similarly, has three subfunctions: Activate Display 932, Activate Moving Indicator 934, and Activate Moving Indicator 936. Each of subfunctions leads into Win Step 932 which leads back to the Placement of Wager Step 922. The Win Step 934 can also lead to the Payout Step 940.

The first step of the operation is the Initiate Step 900 wherein the gaming device 4 (shown in FIG. 1), the display device 10, or both may be energized. During Initiate Step 900, the various electrical devices generally associated with the display device 10 could be energized, including, but not limited to, at least one sensor 162 essentially used to detect the location of at least one movable indicator 40 and at least one controller 140 generally associated with the invention. Any software essentially associated with the controller 140 could also be initialized. Any other peripheral electrical devices generally associated with display device 10 that should be activated upon invention startup could also be energized. Upon completion of the initiate step 900, the process could move to the second step or the Reset Step 910.

The Reset Step 910 could essentially initiate the resetting of the various elements and operating parameters of the display device 10, including but not limited to communication device(s) 6 (e.g., at least one movable indicator 40 and/or at least one display 14) to a predetermined position(s), preset parameter(s) and/or predetermined status(es).

To accomplish the resetting of the moveable indicator 40, the controller 142 in at least one embodiment could activate at least one actuator 18 or drive mechanism 600 (in communication with the moveable indicator 40) to propel the movable indicator 40 to at least one reset stop position 16 on the gaming display 12. One the movable indicator 40 had reached the reset stop position, sensor(s) 162 assigned to the position would notify the controller 140 to stop the action of the actuator 18 or drive mechanism 600. In at least one embodiment, the resetting of at least one movable indicator could be accomplished by the activation of an actuator 18 or drive mechanism 600 to place the moveable indicator 40 in generally continuous motion.

Similarly, any associated displays 14 in communication with an actuator 18 (e.g., solenoid actuator 180) could also be reset to their designated reset position in resetting function step 910. Upon completion of the Reset Function 910, the operation would go on to the Indicating Function loop 912.

The indicating function loop 912 could have three subfunctions 916, 918, 920, and a Placement of Wager decision 922. The three subfunctions could be: Activate Display subfunction 916; Activate Movable Indicator Primary Movement subfunction 918; and Activate Movable Indicator Secondary Movement subfunction 920. One or more of the above-named subfunctions could be used simultaneously or sequentially during the play function 914 to provide stimuli to essentially excite participants or others; to generally inform the participants or others on how the indication of winning is accomplished; to essentially provide other communication that is not directly concerned with the actual playing by the participants.

In the Indicating Function Loop 912, the controller 142, in at least one embodiment of the invention, could, without input from a suitable device such as a random number generator or other control systems, generally cause the display device 10 to emit non-wagering stimuli, information or other communication through the simultaneous or sequential activation of one or more above-named subfunctions 916, 918, 920. At the completion of the activation of one or more of the above subfunctions, the operation could move onto Placement of Wager step 922 where the wager(s) information of the player is accepted.

In the Movable Indicator Primary Movement Subfunction 918, the controller 140 could, without gaming data input from another device or controller subdevice, generally activate or change the operating state of at least one actuator 18 or drive mechanism 600 or any combination thereof resulting in the change of operation, status, activity, pattern of one communication device 6 (e.g., a movable indicator 40 regarding its movement along at least a portion of the pathway; a display 22 to popup from the surface of the display face 12). The change could be random or pre-determined depending on the operation requirements of the particular embodiment of the invention. In at least one embodiment, the positioning of the movable indicator 40 would be fed back to the controller 140 or other controlling means by the activation of sensors 162 due to the proximate presence of the moveable indicator 40.

Upon activation of the Movable Indicator Secondary Movement Subfunction 920, the controller 150 could affect the operation of additional actuators 18 (not shown) generally associated with a communication device 6 (e.g., a movable indicator 40) to generally produce supplemental stimulus (e.g., vibration, popup movement, and the like). In at least one embodiment, wherein at least one movable indicator 40 is in motion along it respective pathway, one or more add ional actuators 18 could be activated by the controller 140 or other controlling means to cause a figure portion of the movable indicator 40 to popup away from the display surface 12 and then vibrate. After a period of time, the controller 140 or other controlling means would deactivate the vibrating additional actuator(s) 18 (not shown) to stop this secondary activity of the moveable indicator 40. Alternatively, the controller 140 or other controlling means could cause the activation of another supplemental or secondary actuator 18 to recede the figurine portion of the moveable indicator 40 back to its original position.

Alternately, or in addition to the above embodiments, a secondary actuator 18 (not shown) could also generally control the orientation of the figure portion of the movable indicator 40 during its travel along the pathway. In this manner, when an actuator 18 or drive mechanism 600 has moved the movable indicator 40 to an certain destination (e.g., stop position 16) and causes the moveable indicator 40 to move in an opposite direction, the additional actuator 18 could orient the designated front of the movable indicator 40 to the new direction of travel that the drive mechanism 600 or actuator 18 will impose upon the movable indicator 40.

Activation of the Activate Display subfunction 916 could cause selected one or more displays 14 enabled with actuators 18 to move or produce or other controller-governed stimuli. For example, energized actuators 18 (e.g., solenoid actuators 180) could cause the selected display 14 to vibrate (e.g., the three dimensional blimp of gaming display 34) and then could project from the display surface 12.

Upon the completion of duties by any of the above subfunctions activated by the Indicating Function Loop 912, the operation could proceed to the Placement of Wager step 922. At this step, wager information for the player(s) is accepted and/or is transmitted to the gaming device 10. If no wager or other is placed/other suitable or desired activity commenced with the gaming device(s) 10 within a certain time or other parameters set by the operator of the invention, then operation proceeds back to the Indicating Function Loop 912. If the input of wager information or other suitable activity associated with the gaming device(s) occurs, then the operation cuts short any initiated activities of subfunctions 916, 918 and 920 before passing onto the Gaming Function Loop 930.

At the Gaming Function Loop 930 essentially undertakes those steps (not shown, but known to the art) to generally process any wager information from the Placement of Wager step 922 to determine win, lose or draw for the received wager(s). Upon completion of wager information processing, the Gaming Function Loop 930 could then generally communicate to the player or others the processed wager information.

To effectively carry out this communication, the Gaming Function loop 930 could utilize one or more of the following components: subfunctions 932, 934, 936; Win step 938, Payout step 940. The Gaming Function loop's 930 three subfunctions (e.g., Activate Display 932, Activate Movable Indicator Primary Movement 932, and Activate Moveable Indicator Secondary Movement 936) provide essentially the same communication activities as their three counterpart subfunctions 916, 918 and 920 accomplish for the Indicating Function Loop 912. Additionally, the Gaming Function loop's 930 three subfunctions 932, 934, 936 could provide the player and others with wager-related information through the initiating the activity of at least one communication device 6. Once any activated subfunctions 932, 934, 936 have essentially completed their duties (e.g., activating or otherwise altering the status or activities of at least one communication device 6 to indicate the winning of a prize, size of the price, loss of wager, and/or gaming information/communication/stimulation, etc.) the operation can then proceed to the Win step 938.

The Win step 938 could be a decision: if a gaming device 10 has previously determined or received data that the player(s) has won a prize(s), the operation could move onto the Payout Step 940 for transmitting or otherwise communicating to the winning participant(s)/player(s), the prize(s) or data about the prize(s). If the payer does not receive a prize at this step, the process can loop back to the Placement of Wager step 922.

If the process proceeds to Payout Step 940 where the payout is made or credited towards the player, then the operation can process back to the Placement of Wager step 922.

### CONCLUSION

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

1. A display device in communication with at least one gaming device comprising,
a) at least one display face, the display face having at least one movable indicator and at least one display;
b) the moveable indictor positioned proximate to the display face;
c) the display positioned proximate to the display device;
d) a first actuator coupled to the movable indicator, the first actuator being configured to move the movable indicator in a first dimension;
e) a second actuator coupled to the movable indictor, the second actuator being configured to move the movable indicator in a second dimension, wherein the first and second indicator together may cause the movable indicator to move in at least two dimensions and may position the movable indicator proximate to the display.

2. The display device of claim 1 wherein the positioning of the movable indicator proximate to display is used to communicate gaming information.

3. The display device of claim 2 wherein the gaming information is notice of the termination of game play.

4. The display device of claim 2 wherein the gaming information is the notice of winning at least one prize

5. The display device of claim 1 further comprising of a third actuator connected to the display.

6. The display device of claim 1 wherein the third actuator imparts motion to the display when the movable indicator moves proximate to the display.

7. The display device of claim 1 wherein the movement of the movable indicator follows a pathway located proximate to the display face, the pathway having at least one non-linear feature.

8. The display device of claim 1 wherein the display face is slanted.

9. The display device of claim 1 further comprises of at least one control system, which governs at least a portion of the operation of the first and second actuators.

10. The display device of claim 1 wherein the first actuator uses a propulsion device from a set of propulsion devices consisting of: rotating threaded shaft, rack and pinion, movement along the slot, elastomeric band, powered wheels.

11. The display device of claim 1 wherein the second actuator uses at least one propulsion device from a set of propulsion devices consisting of: rotating threaded shaft, rack and pinion, movement along the slot, elastomeric band, powered wheels.

12. An gaming device actuator comprising,
a) at least one propulsion device, the propulsion device configured to provide rotational motion;
b) a pinion coupled to the propulsion device, the pinion configured to transfer rotational motion;
c) a rack, which is coupled to the pinion, the rack being configure to provide linear motion;
d) a movable indicator coupled to the rack, the movable indicator being configured further providing movement to a movable indicator proximate located proximate to a display face of a display device, which is associated with a gaming device, wherein the movable indicator is moved to a predetermined position proximate to display face to communicate gaming information.

13. The actuator of claim 12 wherein the gaming information is at least one notice for a set of notices consisting of: notice of game termination, notice of winning of at least one prize.

14. The actuator of claim 12 wherein the predetermined position is located proximate to a display on the display face.

15. The actuator of claim 12 wherein the display face is slanted.

16. The actuator of claim 12 further comprising of a controller, which governs at least a portion of the operation of the propulsion device

17. A gaming device comprising:
(A) at least one gaming device configured to allow at least one player to play at least one game, the gaming device is in communication with at least one display device; and
(B) the display device having at least one display face, at least one communication device and at least one movement apparatus, the movement apparatus providing the communication device with multi-directional movement in relation to the display face.

18. The gaming device of claim 18 wherein the movement apparatus is comprised of at least one actuator that has at least one rotatable threaded shaft.

19. The gaming device of claim 19 wherein the rotatable threaded shaft is indirectly connected to a propulsion device.

20. The gaming device of claim 18 wherein the movement apparatus is comprised of at least one actuator that operates a rack.

21. The gaming device of claim 21 wherein the rack is movably connected to a propulsion device through a movable pinion.

22. The gaming device of claim 18 wherein the movement apparatus can be further defined as a plurality of actuators acting in concert to provide movement to at least one communication device.

23. The gaming device of claim 23 wherein at least one actuator from the plurality of actuator has at least one anti-rotation device.

24. The gaming device of claim 18 wherein the movement has at least one non-linear component.

25. The gaming device of claim 18 wherein the display face is slanted.

26. The gaming device of claim 18 further comprises of a control system which governs at least in part of the operation of the movement apparatus.

27. The gaming display of claim 18 wherein the communication device is associated with at least one stop position relative to the display face.

28. The gaming display of claim 18 further comprising of a pathway along which the communication device is propelled, the pathway being located proximate to the display face.

29. The gaming device of claim 18 wherein the multi-dimensional movement includes at least two dimensional movement.

30. A gaming device, comprising:
(A) a gaming device, which is associated with a display device, is comprised of least one controller system, which can at least in part govern at least part of the operation of the display device;
(B) the display device comprising of at least one slanted display face, at least one communication device, and at least one movement apparatus;
(C) wherein the movement apparatus is associated with the communication device to impart movement to the said communication device relative to the slanted display face.

31. The display device of claim 31 wherein the communication device follows a pathway located proximate to the slanted display surface.

32. The display device of claim 32 wherein the pathway comprises of at least one non-linear component.

33. The display device of claim 33 wherein the non-linear component is a geometric feature selected from a group of geometric features consisting of: a zigzag, a curve, a spiral, a loop.

34. The display device of claim 26 wherein the zigzag has a generally vertical orientation.

35. The display device of claim 31 wherein the communication device is at least one display associated with at least one stop position located proximate to the display face.

36. The display device of claim 31 wherein the movement apparatus comprises of at least one actuator, which utilizes one or more components of a set of components consisting of: movable rack, movable pinion, movable threaded shaft, propulsion device.

37. A gaming device comprising:
(A) a gaming means for allowing at least one player to play a game;
(B) at least one display face means for displaying the results of at least one game;
(C) at least one display means for providing a visual communication for the results of at least one game;
(D) at least one movable indicator means for selecting at least one display means; and
(E) at least one movement apparatus means for providing multi-dimensional movement to the moveable indicator means in relation to the display face means.

38. A gaming device of claim 37 wherein the movement apparatus means is a plurality of actuators means combined together to act in concert

39. A gaming device of claim 38 wherein the display means associated with a stop position means that is located proximate to the display face means.

40. A gaming display of claim 38 wherein one of actuator means utilizes at least one propulsion means selected from set of propulsion means consisting of: a rack and pinion means, a rotating threaded shaft means, a moving belt means, a sliding platform means; a solenoid means.

41. A gaming display of claim 38 wherein the movement of the moveable indicator means relative to the display face means follows a pathway means which has profile with at least two dimensions.

42. A gaming display of claim 37 wherein the multiple dimensional movement includes two dimensional movement.
